(19) United States
(12) Patent Application Publication
(10) Pub. No.: US 2019/0123584 A1
(43) Pub. Date: Apr. 25, 2019

(54) POWER TRANSMISSION DEVICE

(71) Applicant: Daisuke Yoshizawa, Aichi (JP)

(72) Inventor: Daisuke Yoshizawa, Aichi (JP)

(21) Appl. No.: 15/898,169

(22) Filed: Feb. 15, 2018

(30) Foreign Application Priority Data
Mar. 14, 2017 (JP) 2017-048500

(51) Int. Cl. H02J 50/12; H02J 50/40

(52) U.S. Cl. CPC H02J 50/12; H02J 50/40

(57) ABSTRACT

A power transmission device wirelessly transmits power to a power receiving device. The power transmission device includes: a power supply surface that allows the power receiving device to be placed thereon; a peripheral edge portion disposed so as to surround an outer periphery of the power receiving device placed on the power supply surface; a first power transmission coil disposed on a side opposite to the power supply surface to transmit the power by a first transmission method; and a second power transmission coil disposed in the peripheral edge portion to transmit the power by a second transmission method.

### CROSS-REFERENCES TO RELATED APPLICATIONS

This application is based upon and claims the benefit of priority from Japanese Patent Application No. 2017-048500, filed on Mar. 14, 2017, the entire contents of which are incorporated herein by reference.

### FIELD

One or more embodiments of the invention relate to a power transmission device which wirelessly transmits power to a power receiving device, and more particularly relate to a power transmission device which transmits power in a contactless manner by using two different coexisting coils.

### BACKGROUND

In the related art, a power transmission device has been proposed which wirelessly transmits power to a power receiving device. For example, JP-A-2015-144508 discloses a wireless power transmission system which can correspond to two transmission methods and can suppress poor power transmission efficiency from the power transmission device to the power receiving device. The wireless power transmission system wirelessly transmits the power from the power transmission device to the power receiving device by using magnetic field coupling between a power transmission coil and a power receiving coil. The power transmission device has a power transmission circuit that generates an electric signal for power transmission, a first power transmission coil that corresponds to a first transmission method, a second power transmission coil that corresponds to a second transmission method, a first magnetic substance on which the first power transmission coil is placed, a second magnetic substance on which the second power transmission coil is placed, and a power supply surface on which the power receiving device is placed. A first attachment surface of the first magnetic substance and a second attachment surface of the second magnetic substance are located on a lower side of the power supply surface, and are disposed on the same plane parallel to the power supply surface. In the power transmission device, a magnetic flux generated by the first power transmission coil is concentrated inside the first magnetic substance. In this manner, the power transmission device can suppress the magnetic field coupling between the first power transmission coil and the second power transmission coil. In addition, a magnetic flux generated by the second power transmission coil is concentrated inside the second magnetic substance. In this manner, the power transmission device can suppress the magnetic field coupling between the first power transmission coil and the second power transmission coil.

JP-A-2013-098846 discloses a contactless wireless communication coil and a portable wireless terminal which can realize space saving while suppressing poor performance of each coil in a case where a plurality of coils such as contactless wireless communication coils and contactless power transmission coils coexist. The contactless wireless communication coils are disposed by sequentially stacking a first magnetic substance, a first contactless power transmission coil, a second magnetic substance, a board, a second contactless wireless communication coil in this order in a thickness direction of the coils. The second coil is located on an external device side. The first coil and the second coil are disposed in a state where both the coils at least partially overlap each other. Both the coils are disposed so as to have a region where the second coil does not overlap an inner peripheral side of the first coil and the first coil overlaps the second coil near an outer periphery of the first coil. A resonance frequency of the first coil is lower than a resonance frequency of the second coil, and permeability of the first magnetic substance is higher than permeability of the second magnetic substance.

JP-A-2013-106428 discloses a contactless charging base which aims to realize efficient charging even while a vehicle is traveling. The contactless charging base has a case, a charger disposed on an inner surface portion of the case, a guide unit for guiding a charging unit of a portable device to a position parallel to the charger, and a pressing unit which pinches the portable device in the thickness direction by using the guide unit. A configuration is adopted in which a distance between the pressing unit and the guide unit in the thickness direction of the portable device is gradually widened in an insertion direction of the portable device.

### SUMMARY

In recent years, while portable terminals such as smartphones have come into wide use, many standards for contactless charging have been introduced. For example, the Qi standard, the PMA standard, and the A4WP standard have been introduced so far. Some of the standards are mutually compatible or incompatible in terms of hardware and software. The Qi standard and the PMA standard adopt an electromagnetic induction method, and can share the hardware (power transmission coil). On the other hand, the A4WP standard adopts a magnetic field resonance method, and is incompatible with the Qi standard in using the power transmission coil. Thus, the A4WP standard requires a dedicated power transmission coil. In view of usability of users, it is preferable that a single contactless charger can correspond to many standards.

However, if both the power transmission coil conforming to the Qi standard/the PMA standard and the power transmission coil conforming to the A4WP standard are disposed in a miniaturized device, the coils interfere with each other due to mutual inductance. Consequently, an inductance value fluctuates, thereby causing poor charging performance. It is understood that the poor performance conspicuously occurs in a case of the magnetic field resonance method as in the A4WP standard.

One or more embodiments of the invention are made in view of the above-described circumstances, and an object thereof is to provide a power transmission device having satisfactory charging efficiency by reducing the influence of mutual inductance in two power transmission coils conforming to mutually different standards.

In order to solve the above-described problem, there is provided a power transmission device which wirelessly transmits power to a power receiving device. The power transmission device includes a power supply surface that allows the power receiving device to be placed thereon, a peripheral edge portion disposed so as to surround an outer periphery of the power receiving device placed on the power supply surface, a first power transmission coil disposed on a side opposite to the power supply surface to transmit the power by a first transmission method, and a second power transmission coil disposed in the peripheral edge portion to transmit the power by a second transmission method.

According to this configuration, whereas the first power transmission coil is disposed on the side opposite to the power supply surface, the second power transmission coil is disposed in the peripheral edge portion on the power supply surface which surrounds the outer periphery of the power receiving surface. In this manner, it is possible to reduce a magnetic flux interlinking with the first power transmission coil within a magnetic flux generated by the second power transmission coil. Accordingly, it is possible to provide the power transmission device having satisfactory charging efficiency by reducing the influence of mutual inductance.

Furthermore, the first power transmission coil may correspond to an electromagnetic induction method, and the second power transmission coil may correspond to a magnetic field resonance method.

According to this configuration, in a charging device conforming to both standards of the magnetic field resonance method and the electromagnetic induction method, the coil using the electromagnetic induction method is disposed on the side opposite to the power supply surface, and the coil using the magnetic field resonance method is disposed in the peripheral edge portion. In this manner, the influence of the mutual inductance is reduced, and thus, it is possible to provide the power transmission device having the satisfactory charging efficiency when the charging is performed by the power transmission coil using the magnetic field resonance method.

Furthermore, the power receiving device may be a portable terminal, and the peripheral edge portion may have a height from the power supply surface which is equal to or greater than at least a thickness of the portable terminal.

According to this configuration, the peripheral edge portion has the height which is equal to or greater than the thickness of the portable terminal. In this manner, even in a case where the power transmission device is mounted on a vehicle, the portable terminal does not slip therefrom.

As described above, according to one or more embodiments of the invention, it is possible to provide the power transmission device having the satisfactory charging efficiency by reducing the influence of the mutual inductance in two power transmission coils conforming to mutually different standards.

### BRIEF DESCRIPTION OF THE DRAWINGS

FIG. 1A is a plan view of a power transmission device according to a first embodiment of the invention;

FIG. 1B is a sectional view taken along line A-A in FIG. 1A;

FIG. 2 is a sectional view illustrating a magnetic force line generated by a second power transmission coil in the power transmission device according to the first embodiment of the invention;

FIG. 3A is a schematic view illustrating that a current flows in an electromagnetic induction coil due to a magnetic flux generated by a magnetic field resonance coil in a power transmission device in the related art; and

FIG. 3B is a schematic view illustrating that the power transmission device is coupled to a power receiving device by the current flowing in the electromagnetic induction coil.

### DETAILED DESCRIPTION

In embodiments of the invention, numerous specific details are set forth in order to provide a thorough understanding of the invention. However, it will be apparent to one of ordinary skill in the art that the invention may be practiced without these specific details. In other instances, well-known features have not been described in detail to avoid obscuring the invention.

Hereinafter, an embodiment of the invention will be described with reference to the drawings. First, referring to FIGS. 4A and 4B, a power transmission device 100Z in the related art will be described. In the drawings, a housing of the power transmission device 100Z is not illustrated, and a coil accommodated inside the housing is mainly illustrated. The power transmission device 100Z wirelessly transmits power to a power receiving device RD such as a smartphone. The power receiving device RD internally has a power receiving function which is applicable to a transmission method of the power transmission device 100Z, and is placed on a power supply surface 60 of the housing of the power transmission device 100Z. In this manner, the power receiving device RD is charged by receiving power supplied from the power transmission device 100Z.

The power transmission device 100Z includes a first power transmission coil 10 that transmits the power by using an electromagnetic induction method, and a second power transmission coil 20 that transmits the power by using a magnetic field resonance method. The electromagnetic induction method is used in transmitting the power by causing a power receiving side coil to generate an electromotive force by means of electromagnetic induction caused due to a change in a magnetic field generated by a power transmission side coil. The magnetic field resonance method is used in transmitting the power by matching a frequency of the power transmission side coil and a frequency of the power receiving side coil, and in such a way that vibrations of the magnetic field generated by a current flowing in the power transmission side coil are transmitted to a power receiving side resonance circuit which resonates at the same frequency.

According to the electromagnetic induction method, a magnitude of the magnetic flux greatly affects power transmission efficiency, and a magnitude of a coupling coefficient between the power transmitting side coil and the power receiving side coil determines a magnitude of the transmitted power. The magnitude of the coupling coefficient is affected by a distance between both coils or a coincidence degree of coil center positions. According to the magnetic field resonance method, the magnitude of the magnetic flux may be small. Instead, a height of peaky performance (property which sensitively responds to a prescribed frequency) in the power transmitting side coil and the power receiving side coil (antenna) greatly affects the power transmission efficiency. According to the magnetic field resonance method, the magnitude of the magnetic flux rarely relates to the power transmission efficiency. Accordingly, the magnetic field resonance method has a characteristic that the power can be transmitted even if the power transmission side coil and the power receiving side coil are separated from each other. On the other hand, the power transmission efficiency is likely to receive the influence of surrounding coils or the magnetic flux. That is, in the power transmission efficiency according to the magnetic field resonance method, it is important how closely a resonance frequency of the power transmission side coil can coincide with a resonance frequency of the power receiving side coil.

In particular, in the power transmission device such as the power transmission device 100Z including the first power transmission coil 10 using the electromagnetic induction method and the second power transmission coil 20 using the magnetic field resonance method, the power transmission device receives the influence of mutual inductance between the power transmission side coil and the power receiving side coil. That is, the reason is as follows. In the vicinity of the second power transmission coil 20 using the magnetic field resonance method, the first power transmission coil 10 using its own electromagnetic induction method is present, and the power receiving coil of the power receiving device RD approaching the vicinity in order to improve the power transmission efficiency in the electromagnetic induction method is also present.

As illustrated in the drawings, in the power transmission device 100Z, the first power transmission coil 10 using the electromagnetic induction method and the second power transmission coil 20 using the magnetic field resonance method are located in the vicinity of the power supply surface 60, that is, in the vicinity of the power receiving device RD. Both of these are located with approximately the same distance from the power receiving side coil of the power receiving device RD. FIG. 4A illustrates that an upward magnetic flux ML is generated by a current flowing in the second power transmission coil 20 using the magnetic field resonance method. In this case, the magnetic flux ML interlinks with the first power transmission coil 10 using the electromagnetic induction method, and in compliance with the interlinkage, a current CR flows in the first power transmission coil 10 using the electromagnetic induction method.

In this case, as illustrated in FIG. 4B, coupling occurs between the first power transmission coil 10 using the electromagnetic induction method and the power receiving side coil of the power receiving device RD. If the coupling occurs, the mutual inductance is changed, and the resonance frequency of the power receiving side coil fluctuates. Consequently, due to high peaky performance, the second power transmission coil 20 using the magnetic field resonance method comes to have poor power transmission efficiency. If a smartphone of the power receiving device RD is moved on the power supply surface 60 and a distance fluctuates between the first power transmission coil 10/the second power transmission coil 20 and the power receiving side coil, the mutual inductance may vary in some cases. If the mutual inductance fluctuates as described above, the fluctuation causes poor charging performance of the power transmission device 100Z which charges the power receiving device RD.

### First Embodiment

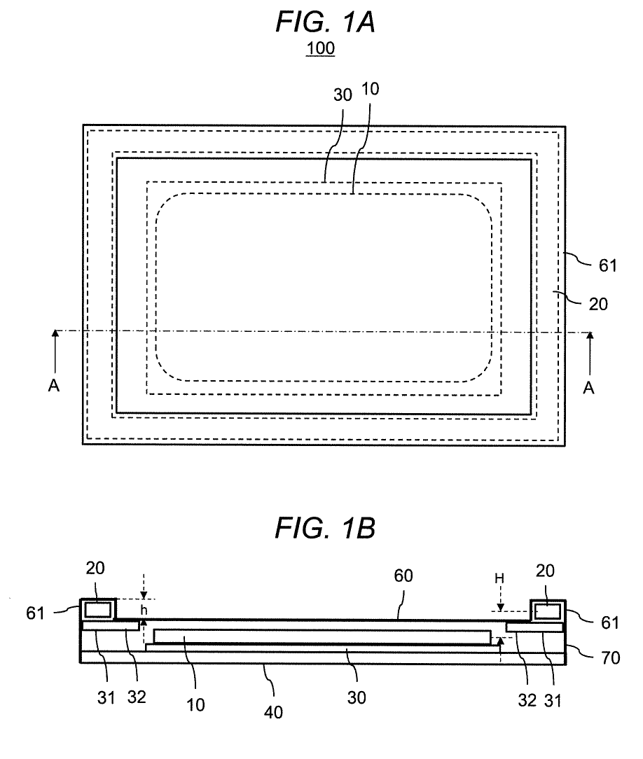

Referring to FIGS. 1A and 1B, a power transmission device 100 according to the present embodiment will be described. The power transmission device 100 wirelessly transmits power to a power receiving device RD such as a portable terminal, and has a power supply surface 60 on which the power receiving device RD is placed. As a so-called wireless charging method of wirelessly supplying the power to the power receiving device RD such as the portable terminal, the power transmission device 100 employs both an electromagnetic induction method using electromagnetic waves having frequencies in a range of approximately from several tens kHz to several hundreds kHz and a magnetic field resonance method using electromagnetic waves having frequencies in a range of approximately from several MHz to several tens MHz.

In order to correspond to two different wireless charging methods, the power transmission device 100 includes a first power transmission coil 10 that transmits the power by using the electromagnetic induction method (first transmission method) and a second power transmission coil 20 that transmits the power by using the magnetic field resonance method (second transmission method). More specifically, the power transmission device 100 includes a control board 40 having a rectangular shape in a plan view, a magnetic substance 30 for strengthening a magnetic field in a rectangular plate shape on the control board 40, a first power transmission coil 10 disposed on a side opposite to the power supply surface 60 so as to be stacked on the power supply surface 60 side of the magnetic substance 30, a peripheral edge portion 61 disposed so as to surround an outer periphery of the power receiving device RD placed on the power supply surface 60, a second power transmission coil 20 disposed in the peripheral edge portion 61, and a magnetic substance 31 for strengthening a magnetic field generated by the second power transmission coil 20 so as to induce a magnetic flux.

The first power transmission coil 10 using the electromagnetic induction method is coupled using the strength of the magnetic flux. Accordingly, the first power transmission coil 10 is preferably located at a central position of the power supply surface 60 as close to the power supply surface 60 as possible. The first power transmission coil 10 is a spiral coil wound in a rectangular and annular shape by using a wiring pattern of conductors formed on the control board 40. In order to strengthen the magnetic field of the first power transmission coil 10, the magnetic substance 30 is configured to include a material having magnetic permeability of 1 or more such as ferrite, and has a rectangular plate shape. A plan view shape thereof is substantially the same as that of the first power transmission coil 10, and the magnetic substance 30 is disposed so as to coincide with the first power transmission coil 10.

The second power transmission coil 20 is disposed inside the peripheral edge portion 61. The peripheral edge portion 61 protrudes as high as a height h from the power supply surface 60 in a rectangular frame shape so as to surround the outer periphery of the power receiving device RD placed on the power supply surface 60. The second power transmission coil 20 is disposed inside a portion protruding as high as the height h from the power supply surface 60, and is disposed on the upper side of the power supply surface 60 when viewed in the drawing. The height h is appropriately determined by the thickness of the power receiving device RD such as the commercially available portable terminal. Preferably, the height h is equal to or greater than the thickness of at least the portable terminal. In this way, the peripheral edge portion 61 has the height equal to or greater than the thickness of the portable terminal. Accordingly, even in a case where the power transmission device 100 is mounted on a vehicle, the portable terminal does not slip therefrom.

The second power transmission coil 20 is a rectangular shaped antenna formed by a wiring pattern of conductors formed inside the peripheral edge portion 61. Unlike the first power transmission coil 10 coupled using the strength of the magnetic flux, the second power transmission coil 20 is not necessarily wound several times for the magnetic field resonance. The second power transmission coil 20 resonates at a predetermined frequency by using its own inductance and stray capacitance. Accordingly, even if the second power transmission coil 20 is located around the power receiving device RD, the power transmission performance is less affected.

The second power transmission coil 20 is located at a height different as high as the height H in the direction perpendicular to the power supply surface 60, compared to the first power transmission coil 10. Due to a difference in positions in the direction perpendicular to the power supply surface 60, in other words, a difference in positions in the direction perpendicular to the coil surface, it is possible to reduce the magnetic force line ML generated by the second power transmission coil 20 and interlinking with the first power transmission coil 10. That is, whereas the first power transmission coil 10 is disposed on the side opposite to the power supply surface 60, the second power transmission coil 20 is disposed in the peripheral edge portion 61 on the power supply surface 60 which surrounds the outer periphery of the power supply device RD. In this manner, it is possible to reduce the magnetic flux interlinking with the first power transmission coil 10 within the magnetic flux generated by the second power transmission coil 20. Accordingly, the influence of the mutual inductance is reduced, and thus, it is possible to provide the power transmission device 100 having the satisfactory charging efficiency.

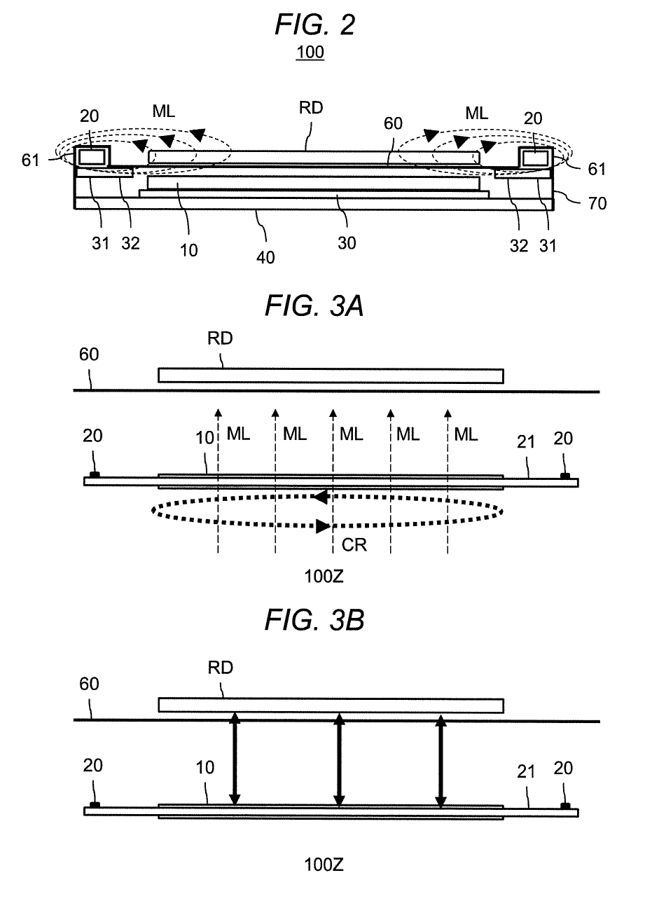

In order to strengthen the magnetic field of the second power transmission coil 20, the magnetic substance 31 is configured to include a material having magnetic permeability of 1 or more such as ferrite, and is disposed on the control board 40 side of the peripheral edge portion 61. The magnetic substance 31 is present on the control board 40 side of the second power transmission coil 20, and has an extending portion 32 extending toward the center side from the peripheral edge portion 61. The extending portion 32 extends to such an extent that the extending portion 32 does not coincide with the first power transmission coil 10 present on the center side in a plan view. As illustrated in FIG. 2, the extending portion 32 induces the magnetic flux so that the magnetic force line ML generated by the second power transmission coil 20 does not affect the first power transmission coil 10. In this manner, it is possible to further reduce the magnetic flux interlinking with the first power transmission coil 10 within the magnetic flux generated by the second power transmission coil 20.

The power transmission device 100 further includes the power transmission circuit (not shown) that generates the electric signal for the first power transmission coil 10 and the second power transmission coil 20, on the control board 40. The power transmission circuit internally has a first power transmission circuit corresponding to the first power transmission coil 10 and a second power transmission circuit corresponding to the second power transmission coil 20, which are configured to include a circuit such as an inverter circuit. The first power transmission circuit generates the electric signal for power transmission corresponding to the electromagnetic induction method. As the electric signal corresponding to the electromagnetic induction method, the electric signal of an alternating current having a frequency of approximately several tens kHz to several hundreds kHz is usually used. The second power transmission circuit generates the electric signal for power transmission corresponding to the magnetic field resonance method. As the electric signal corresponding to the magnetic field resonance method, the electric signal of the alternating current having a frequency of approximately several MHz to several tens MHz is usually used.

In addition to the power transmission circuit, the control board 40 has a detection circuit, a control circuit, and a switch (not illustrated). Based on a predetermined control signal or operation, the control board 40 can select whether to transmit the power by using any one of the electromagnetic induction method and the magnetic field resonance method. The power transmission circuit applies the generated electric signal to the first power transmission coil 10 or the second power transmission coil 20 using selected method. The detection circuit is installed in the vicinity of the power supply surface 60, and detects a signal of the power receiving device RD. In this manner, for example, based on the frequency of the received signal, the detection circuit determines whether the power receiving device RD is the power receiving device using the electromagnetic induction method or the power receiving device using the magnetic field resonance method. If necessary, the power transmission circuit can simultaneously apply the electric signals to the first power transmission coil 10 and the second power transmission coil 20.

While the invention has been described with respect to a limited number of embodiments, those skilled in the art, having benefit of this disclosure, will appreciate that other embodiments can be devised which do not depart from the scope of the invention as disclosed herein. According, the scope of the invention should be limited only by the attached claims.

1. A power transmission device which wirelessly transmits power to a power receiving device, the power transmission device comprising:
a power supply surface that allows the power receiving device to be placed thereon;
a peripheral edge portion disposed so as to surround an outer periphery of the power receiving device placed on the power supply surface;
a first power transmission coil disposed on a side opposite to the power supply surface to transmit the power by a first transmission method; and
a second power transmission coil disposed in the peripheral edge portion to transmit the power by a second transmission method.

2. The power transmission device according to claim 1,
wherein the first power transmission coil corresponds to an electromagnetic induction method, and
wherein the second power transmission coil corresponds to a magnetic field resonance method.

3. The power transmission device according to claim 1,
wherein the power receiving device is a portable terminal, and
wherein the peripheral edge portion has a height from the power supply surface which is equal to or greater than at least a thickness of the portable terminal.
